(19) United States
(12) Patent Application Publication
(10) Pub. No.: US 2017/0244964 A1
(43) Pub. Date: Aug. 24, 2017

(54) Method and Apparatus of Flexible Block Partition for Video Coding

(71) Applicant: MEDIATEK INC., Hsin-Chu (TW)

(72) Inventors: Shan LIU, San Jose, CA (US); Xiaozhong XU, State College, PA (US)

(21) Appl. No.: 15/436,915

(22) Filed: Feb. 20, 2017

Related U.S. Application Data
(60) Provisional application No. 62/298,518, filed on Feb. 23, 2016.
(60) Provisional application No. 62/309,485, filed on Mar. 17, 2016.

(51) Int. Cl. H04N 19/119; H04N 19/61; H04N 19/44; H04N 19/46

(52) U.S. Cl. CPC H04N 19/119; H04N 19/46; H04N 19/61; H04N 19/44; H04N 19/176

(57) ABSTRACT

A method and apparatus for video coding using flexible block partition structure are disclosed. The coding unit is partitioned into one or more prediction units according to a prediction binary tree structure corresponding to one or more stages of binary splitting. A respective predictor for each prediction unit is generated according to a selected prediction mode for each prediction unit. At the encoder side, prediction residuals are generated for the coding unit by applying a prediction process to each prediction unit using the respective predictor. At the decoder side, the reconstructed prediction residuals for the coding unit are derived from the video bitstream. A reconstructed coding unit is generated by reconstructing each prediction unit in the coding unit based on the respective predictor and reconstructed prediction residuals of each prediction unit according to the prediction process. Also, T-shaped and L-shaped prediction unit partitions are disclosed.

### CROSS REFERENCE TO RELATED APPLICATIONS

The present invention claims priority to U.S. Provisional patent application, Ser. No. 62/298,518, filed on Feb. 23, 2016 and U.S. Provisional patent application, Ser. No. 62/309,485, filed on Mar. 17, 2016. The U.S. Provisional patent applications are hereby incorporated by reference in their entireties.

### FIELD OF THE INVENTION

The present invention relates to block partition for coding and/or prediction process in video coding. In particular, a flexible block structure for coding/prediction and new block partition types for prediction are disclosed to improve coding performance.

### BACKGROUND AND RELATED ART

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC). In HEVC, one slice is partitioned into multiple coding tree units (CTU). In main profile, the minimum and the maximum sizes of CTU are specified by the syntax elements in the sequence parameter set (SPS). The allowed CTU size can be 8×8, 16×16, 32×32, or 64×64. For each slice, the CTUs within the slice are processed according to a raster scan order.

The CTU is further partitioned into multiple coding units (CU) to adapt to various local characteristics. A quadtree, denoted as the coding tree, is used to partition the CTU into multiple CUs. Let CTU size be MxM, where M is one of the values of 64, 32, or 16. The CTU can be a single CU (i.e., no splitting) or can be split into four smaller units of equal sizes (i.e., M/2×M/2 each), which correspond to the nodes of the coding tree. If units are leaf nodes of the coding tree, the units become CUs. Otherwise, the quadtree splitting process can be iterated until the size for a node reaches a minimum allowed CU size as specified in the SPS (Sequence Parameter Set). This representation results in a recursive structure as specified by a coding tree (also referred to as a partition tree structure) 120 in FIG. 1. The CTU partition 110 is shown in FIG. 1, where the solid lines indicate CU boundaries. The decision whether to code a picture area using Inter-picture (temporal) or Intra-picture (spatial) prediction is made at the CU level. Since the minimum CU size can be 8×8, the minimum granularity for switching between different basic prediction types is 8×8.

Furthermore, according to HEVC, each CU can be partitioned into one or more prediction units (PU). Coupled with the CU, the PU works as a basic representative block for sharing the prediction information. Inside each PU, the same prediction process is applied and the relevant information is transmitted to the decoder on a PU basis. A CU can be split into one, two or four PUs according to the PU splitting type. HEVC defines eight shapes for splitting a CU into PU as shown in FIG. 2, including 2N×2N, 2N×N, N×2N, N×N, 2N×nU, 2N×nD, nL×2N and nR×2N partition types. Unlike the CU, the PU may only be split once according to HEVC. The partitions shown in the second row correspond to asymmetric partitions, where the two partitioned parts have different sizes. The partitions and associated part_mode (i.e., partition mode) binarization are listed in the following table.

TABLE 1
Binarization for part_mode

| | | | Bin string | | | |
|---|---|---|---|---|---|---|
| | | | log2CbSize > | | log2CbSize == | |
| CuPredMode | | | MinCbLog2SizeY | | MinCbLog2SizeY | |
| [xCb][yCb] | part_mode | PartMode | !amp_enabled_flag | amp_enabled_flag | log2CbSize == 3 | log2CbSize > 3 |
| MODE_INTRA | 0 | PART_2Nx2N | — | — | 1 | 1 |
| | 1 | PART_NxN | — | — | 0 | 0 |
| MODE_INTER | 0 | PART_2Nx2N | 1 | 1 | 1 | 1 |
| | 1 | PART_2NxN | 01 | 011 | 01 | 01 |
| | 2 | PART_Nx2N | 00 | 001 | 00 | 001 |
| | 3 | PART_NxN | — | — | — | 000 |
| | 4 | PART_2NxnU | — | 0100 | — | — |
| | 5 | PART_2NxnD | — | 0101 | — | — |
| | 6 | PART_nLx2N | — | 0000 | — | — |
| | 7 | PART_nRx2N | — | 0001 | — | — |

In HEVC, the use of Inter motion compensation can be in two different ways: explicit signalling or implicit signalling. In explicit signalling, the motion vector for a block (prediction unit) is signalled by using predictive coding method. The motion vector predictors come from spatial or temporal neighbours of the current block. After prediction, the motion vector difference (MVD) is coded and transmitted. This mode is also referred as AMVP (advanced motion vector prediction) mode. In implicit signalling, one predictor from the predictor set is selected to be the motion vector for the current block (i.e., a prediction unit). In other words, no MVD needs to be transmitted in the implicit mode. This mode is also referred as Merge mode. The generation of predictor set in Merge mode is also referred as Merge candidate list construction. An index, called Merge index, is signalled to indicate which of the predictors is actually used for representing the MV for the current block.

Various block partition structures are disclosed in this invention to improve coding performance. In particular, flexible prediction unit partitions are disclosed.

### BRIEF SUMMARY OF THE INVENTION

A method and apparatus for video coding using flexible block partition structure are disclosed. The coding unit is partitioned into one or more prediction units according to a prediction binary tree structure corresponding to one or more stages of binary splitting. A respective predictor for each prediction unit is generated according to a selected prediction mode for each prediction unit. At the encoder side, prediction residuals are generated for the coding unit by applying a prediction process to each prediction unit using the respective predictor. The coding unit is then encoded by incorporating coded information associated with the prediction residuals into a bitstream. At the decoder side, the reconstructed prediction residuals for the coding unit are derived from the video bitstream. A reconstructed coding unit is generated by reconstructing each prediction unit in the coding unit based on the respective predictor and reconstructed prediction residuals of each prediction unit according to the prediction process.

The prediction binary tree structure is derived from the video bitstream at the decoder side. A first flag in the video bitstream is used for the prediction binary tree structure to indicate whether one given block is split into two blocks of equal size. If the first flag indicates said one given block being split into two blocks of equal size, a second flag in the video bitstream is used for the prediction binary tree structure to indicate horizontal splitting or vertical splitting. An allowed minimum prediction unit size, an allowed minimum prediction unit width or an allowed minimum prediction unit height, or maximum depth associated with the prediction binary tree structure is determined from the video bitstream in sequence parameter set (SPS) or picture parameter set (PPS).

At the decoder side, a third flag can be determined from the video bitstream, where the third flag indicates whether the coding unit and a transform unit associated with the coding unit have a same first block size. If the third flag indicates that the coding unit does not have the same first block size as any transform unit associated with the coding unit, each prediction unit has one corresponding transform unit with a same second block size of said each prediction unit. In this case, the coding unit can also be divided into one or more transform units using one or more stages of quadtree splitting and each transform unit includes only pixels from one prediction unit.

For colour video, a same prediction binary tree structure can be used for the luma component and the chroma component of the coding unit.

In one embodiment, the prediction binary tree structure includes at least one T-shaped partition, where the T-shaped partition divides the coding unit into a first half-block and a second half-block in a first direction corresponding to a vertical direction or a horizontal direction and one of the first half-block and the second half-block is further divided into two quarter-blocks in a second direction perpendicular to the first direction. For example, the prediction binary tree structure comprises four T-shaped partitions and one half-block being further divided to generate one of the four T-shaped partitions corresponds to an upper half-block, a lower half-block, a left half-block or a right half-block. The prediction binary tree structure may further comprise 2N×2N, 2N×N and N×2N partitions. A T-shaped partition enable flag can be signalled to indicate use of the four T-shaped partitions in the prediction binary tree structure, where three first binary strings are used for signalling the 2N×2N, 2N×N and N×2N partitions when the T-shaped partition enable flag indicates the T-shaped partition being disabled. If the T-shaped partition enable flag indicates the T-shaped partition being enabled, one additional bit is appended to each of two first binary strings representing 2N×N and N×2N partitions to indicate whether corresponding 2N×N or N×2N partition is further partitioned into one T-shaped partition. Four second binary strings are used for signalling the four T-shaped partitions and the four second binary strings are generated by appending two bits to each of two first binary strings.

The prediction binary tree structure may comprise AMP (asymmetric motion partition) that includes 2N×N and N×2N partitions. A T-shaped partition enable flag can be used to indicate the use of the four T-shaped partitions in the prediction binary tree structure, wherein first binary strings are used for signalling the AMP when the T-shaped partition enable flag indicates the T-shaped partition being disabled. If the T-shaped partition enable flag indicates the T-shaped partition being enabled, one additional bit is appended to each of two first binary strings representing 2N×N and N×2N partitions to indicate whether corresponding 2N×N or N×2N partition is further partitioned into one T-shaped partition. Four second binary strings are used for signalling the four T-shaped partitions and the four second binary strings are generated by appending two bits to each of two first binary strings.

In another embodiment, L-shaped partition is disclosed for prediction unit partition structure. According to this embodiment, when L-shape partition is selected for the coding unit, the coding unit is partitioned into one or more prediction units according to a prediction structure including at least one L-shaped partition, where the coding unit is partitioned into one quarter-block located at one corner of the coding unit and one remaining-block being three times as large as said one quarter-block. For example, the prediction structure may comprise four L-shaped partitions and said one quarter-block associated with the four L-shaped partitions corresponds to an upper-left quarter-block, a lower-left quarter-block, an upper-right quarter-block or a lower-right quarter-block. The prediction structure may further comprise 2N×2N, 2N×N and N×2N partitions. Four binary strings consisting of a prefix symbol followed by two bits can be used to represent the four L-shaped partitions. Furthermore, an L-shaped partition enable flag can be used to indicate the use of the four L-shaped partitions in the prediction structure, where three first binary strings are used for signalling the 2N×2N, 2N×N and N×2N partitions when the L-shaped partition enable flag indicates the L-shaped partition being disabled. If the L-shaped partition enable flag indicates the L-shaped partition being enabled, one additional bit can be appended to each of two first binary strings representing 2N×N and N×2N partitions to indicate whether corresponding 2N×N or N×2N partition is further modified into one L-shaped partition, and four second binary strings are used for signalling the four L-shaped partitions and the four second binary strings are generated by appending two bits to each of two first binary strings.

### BRIEF DESCRIPTION OF THE DRAWINGS

FIG. 1 illustrates an example of block partition using quadtree structure to partition a coding tree unit (CTU) into coding units (CUs).

FIG. 2 illustrates asymmetric motion partition (AMP) according to High Efficiency Video Coding (HEVC), where the AMP defines eight shapes for splitting a CU into PU.

FIG. 3 illustrates four “T-shaped” prediction unit partitions according to an embodiment of the present invention.

FIG. 4 illustrates four “L-shaped” prediction unit partitions according to an embodiment of the present invention.

FIG. 5A illustrates an example of transform unit partition associated with a “T-shaped” prediction unit partition according to an embodiment of the present invention, where the transform unit is partitioned by quadtree splitting.

FIG. 5B illustrates an example of transform unit partition associated with a “L-shaped” prediction unit partition according to an embodiment of the present invention, where the transform unit is partitioned by quadtree splitting.

FIG. 6A illustrates an example of transform unit partition associated with a “T-shaped” prediction unit partition according to an embodiment of the present invention, where the transform unit is partitioned in the same way as the prediction unit.

FIG. 6B illustrates another example of transform unit partition associated with a “T-shaped” prediction unit partition according to an embodiment of the present invention, where the transform unit is partitioned in the same way as the prediction unit.

FIG. 7 illustrates a flowchart of an exemplary decoding system using a binary tree structure to partition a coding unit into one or more prediction units according to an embodiment of the present invention.

FIG. 8 illustrates a flowchart of an exemplary encoding system using a binary tree structure to partition a coding unit into one or more prediction units according to an embodiment of the present invention.

FIG. 9 illustrates a flowchart of an exemplary decoding system using a prediction unit partition structure including at least one “L-shaped” partition according to an embodiment of the present invention.

FIG. 10 illustrates a flowchart of an exemplary encoding system using a prediction unit partition structure including at least one “L-shaped” partition according to an embodiment of the present invention.

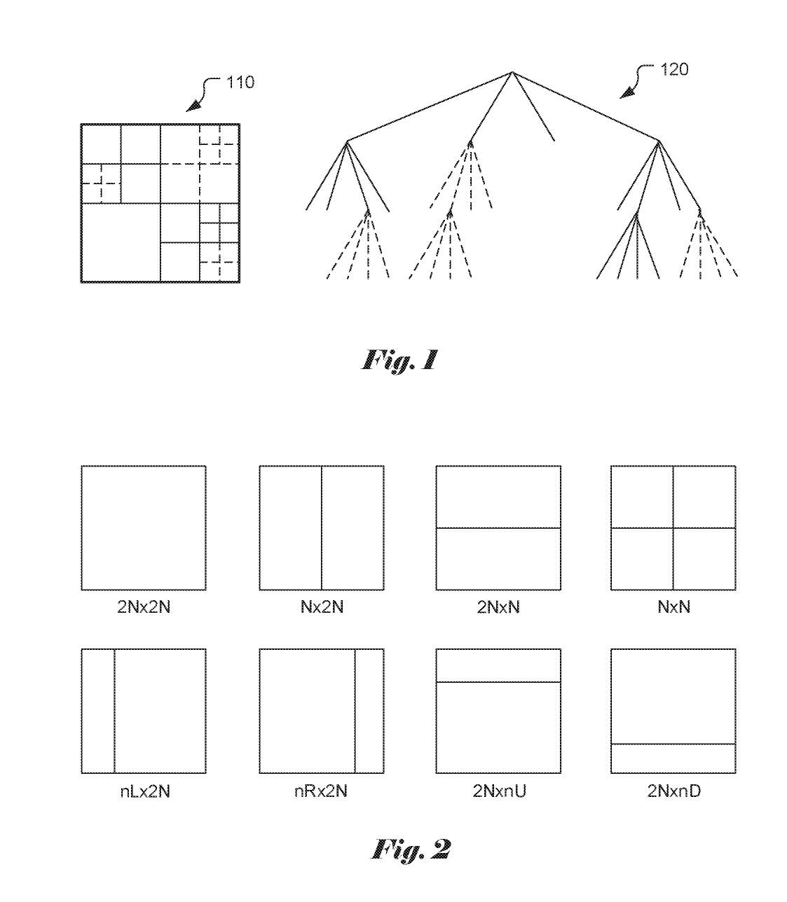

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In one aspect of the present invention, various flexible block structures for the coding, prediction and transform processes are disclosed as follows.

Coding/Prediction Unit Partitioning Using Quadtree/Binary Tree

In one method, in HEVC, the root of a coding unit (i.e., the coding tree unit) is square shaped. Therefore, any smaller coding units are square by quadtree splitting. For a given coding unit, a binary tree is used for the prediction unit partition in order to determine the associated prediction units according to one embodiment of the present invention. Note that the Intra/Inter mode for all the prediction blocks in the coding unit is determined at the coding unit level.

According to an embodiment, for a given prediction unit size M×N, a first flag is used to signal whether it is split into two prediction blocks of equal sizes. This process is performed for prediction unit partition starting from the coding unit. If the first flag indicates that it is split into two prediction blocks, a second flag is signalled to indicate the splitting direction. For example, the second flag equal to 0 means horizontal splitting and the second flag equal to 1 means vertical splitting. The splitting is always symmetrical (i.e., in the middle of the current prediction block). If the horizontal splitting is used, it is split into two prediction blocks of size M×N/2. Otherwise, if the vertical splitting is used, it is split into two prediction blocks of size M/2×N. For each of the split prediction units, it has its own intra prediction mode if the split prediction units are within an Intra coded coding unit. Each of the split prediction units has its own motion information, such as MV, reference index (i.e., ref idx) and reference list (i.e., ref list), etc. if the split prediction units are within an Inter coded coding unit. In the case of M=N, the current prediction unit has the same size as the coding unit.

For each split prediction unit, it can be further split until either the depth (number of splits from coding unit) has reached the allowed maximum or the height or width of the current prediction block has reached the allowed minimum. As is known in the field, for these intermediate blocks that are further split, they do not result in and are not considered as prediction units at the end of partition process. The maximum depth and the minimum width and height can be defined in high level syntax such as in Sequence Parameter Set (SPS) or Picture Parameter Set (PPS). After the maximum or minimum has been reached, no split flag is signalled. When not signalled, it is inferred that no split is applied to current prediction block.

There are several ways to determinate the size of transform unit. In one method, a flag is used to signal whether the transform unit size is equal to the coding unit size. If yes, no further split of the transform unit, if not, each of the prediction unit will have a transform block of the same size. If the prediction block is of the same size of the coding unit, no flag is needed. Note that the transform block according to this method (i.e., transform unit having the same size as the prediction unit) can be either square or non-square depending on the size of its corresponding prediction block. In another method, a flag is used to signal whether the transform unit size is equal to the coding unit size. If yes, no further split of the transform unit; if not, a series of quadtree splitting are applied starting from the coding unit size until none of the square transform units contains pixels from more than one prediction unit. In other words, transform unit will not go across any prediction unit boundary. In this case, all transform blocks are square.

As is known in the field, a coding unit can be partitioned into one or more prediction units and a prediction process is applied to prediction units within the coding unit to generate prediction residuals for the coding unit. The prediction residuals of the coding unit are coded into video bitstream. The coding process applied to prediction residuals may include transform, quantization and entropy coding. For the transform process, each coding unit is partitioned into one or more transform units and transformation is applied to each transform unit. While the phrase “partitioning a coding unit into one or more transform units” is often used, it actually means that the prediction residuals associated with the coding unit are divided into sub-blocks (i.e., transform units). The transformation is applied to the prediction residuals of each transform unit.

For the above mentioned prediction unit and transform unit partitioning, the luma and chroma components share the same splitting tree according to one embodiment. In another embodiment, chroma components can have separate splitting trees. In particular, two chroma components may have different splitting trees.

Flexible Prediction Unit Partitioning

According to this set of embodiments, new prediction unit structures for the coding unit are disclosed.

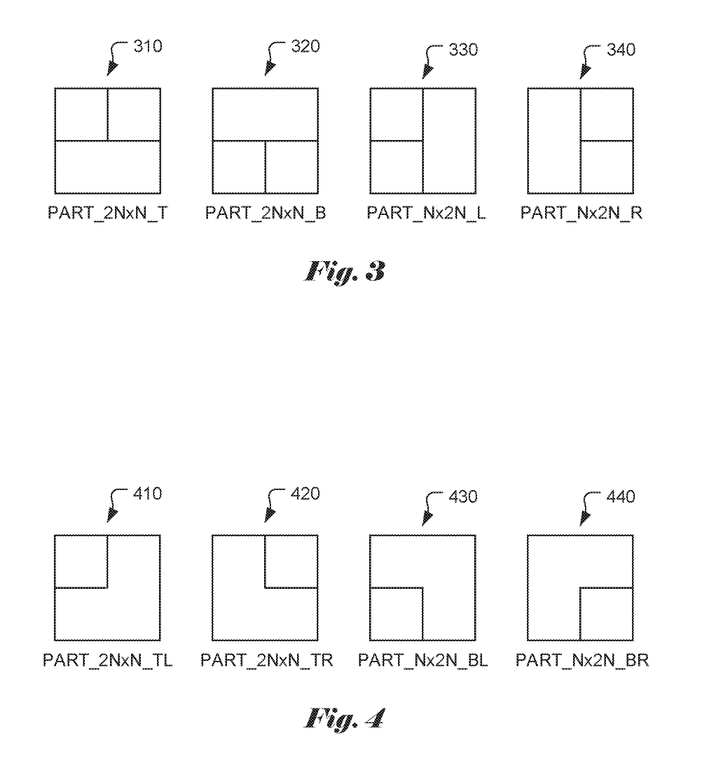

In one embodiment, four new “T-shaped” prediction unit partitions are disclosed, as shown in FIG. 3. In each of these four prediction unit partitions, each CU size of 2N×2N is divided by a 2N×N or N×2N PU, the rest half of the CU is partitioned by two N×N PUs. Therefore, there are all together 3 PUs inside a CU. The “T-shaped” prediction unit partitions are designated as 2N×N_T (310), 2N×N_B (320), N×2N_L (330) and N×2N_R (340) as shown in FIG. 3.

When signalling the use of these new partitions, these partitions can be considered as an extension to the existing 2N×N/N×2N partitions according to one embodiment. For example, the 2N×N_T partition mode (310) in FIG. 3 is equivalent to a sub-division of a 2N×N PU partition structure, which further divides the first PU (i.e., the upper PU) in two halves. In other words, the coding unit is divided into two half-blocks, referred as a first half-block and a second half-block. One of the two half-blocks is further divided into two quarter-blocks. The partition of 2N×N or N×2N can be signalled first, followed by a second binary symbol (i.e., 1 bit or bin) to indicate whether further sub-dividing is needed. If further sub-dividing is needed, another bit or bin (the third bit or bin) is used to signal which of the two partitions is further divided. The case of further sub-dividing can be indicated by the second bin value being a “0” according to one embodiment. Also, the bin value being a “1” can also be used to indicate that further sub-dividing is needed. The third bit or bin being “0” can be used to indicate that the first PU is further sub-divided according to one embodiment. Also, the third bit or bin being “1” can be used to indicate that the first PU is further sub-divided.

As an example, if mode 2N×2N, 2N×N and N×2N are signalled as 1, 01 and 00 in the conventional scheme, then mode 2N×2N, 2N×N and N×2N are signalled as 1, 011 and 001 respectively according to an embodiment of the present invention. In the above example, the bit in bold-Italic font indicates an additional bit added. Equivalently, a new set of binary codes can be generated by flipping the “0” bit and “1” bit (i.e., 1, 010 and 000). The new modes 2N×N_T, 2N×N_B, N×2N_L and N×2N_R can be signalled as 0100, 0101, 0000 and 0001 respectively (or 0101, 0100, 0001 and 0000 respectively). Similarly, if AMP modes co-exist with the new partitions, 1-bin flag can be used following the partitions of 2N×N and N×2N to indicate if further partitioning is needed. For example, mode 2N×2N, 2N×N and N×2N are signalled as 1, 011 and 001 respectively in the conventional scheme and as 1, 0111 and 0011 according to one embodiment, where the last bin being “0” indicates that further split is needed. If yes, another bin is used to indicate which of the two prediction units are to be split. For example, modes 2N×N_T, 2N×N_B, N×2N_L and N×2N_R can be signalled as 01100, 01101, 00100 and 00101 respectively (or 01101, 01100, 00101 and 00100 respectively by assigning 0 or 1 to different sub-division methods). Similar assignment can be applied to the case when 2N×N, N×2N and N×N modes co-exist.

In another method, four new “L-shaped” prediction unit partitions are disclosed, as shown in FIG. 4. In each of these four prediction unit partitions, each coding unit size of 2N×2N is divided into one N×N prediction unit at one of the four corners and the rest part of the coding unit forms another prediction unit having a size three times as large as N×N. Therefore, there are all together 2 prediction units inside the coding unit. The “L-shaped” prediction unit partitions are designated as 2N×N_TL (410), 2N×N_TR (420), N×2N_BL (430) and N×2N_BR (440) as shown in FIG. 4.

According to one embodiment, n signalling the use of these new partitions can be based on the signalling of the conventional prediction unit partition. If mode 2N×2N, 2N×N and N×2N are signalled using the conventional scheme (e.g. 1, 01 and 001), then the four new modes can be signalled as follows. First, a prefix symbol (e.g. a binary string 000) is signalled and followed by two bins to indicate which of the four partitions is used. In one embodiment, modes 2N×N_TL, 2N×N_TR, N×2N_BL and N×2N_BR can be signalled by the four codewords: 00000, 00001, 00010 and 00011 respectively. The four codewords can be assigned to the four new modes in different order from the above example. The four L-shaped partitions can also use the binarization methods described above for the four T-shaped partitions, i.e., treating the four L-shaped partitions as extensions of 2N×N/N×2N modes.

In HEVC, N×N partition is allowed when the current coding unit is the smallest coding unit and is greater than the size of 8×8 (i.e., K=3 in Tables 2 and 3). The following tables illustrate one exemplary binarization of the new partition modes combined with other existing partition modes in HEVC.

TABLE 2

| | | | Bin string | | | |
|---|---|---|---|---|---|---|
| | | | log2CbSize > | | log2CbSize == | |
| CuPredMode | | | MinCbLog2SizeY | | MinCbLog2SizeY | |
| [xCb][yCb] | part_mode | PartMode | !tsp_enabled_flag | tsp_enabled_flag | log2CbSize == K | log2CbSize > K |
| MODE_INTRA | 0 | PART_2Nx2N | — | — | 1 | 1 |
| | 1 | PART_NxN | — | — | 0 | 0 |
| MODE_INTER | 0 | PART_2Nx2N | 1 | 1 | 1 | 1 |
| | 1 | PART_2NxN | 01 | 011 | 01 | 01 |
| | 2 | PART_Nx2N | 00 | 001 | 00 | 001 |
| | 3 | PART_NxN | — | — | — | 000 |
| | 4 | PART_2NxN_T | — | 0100 | — | — |
| | 5 | PART_2NxN_B | — | 0101 | — | — |
| | 6 | PART_Nx2N_L | — | 0000 | — | — |
| | 7 | PART_Nx2N_R | — | 0001 | — | — |

In Table 2, tsp_enabled_flag is used to signal the use of T-Shaped Partitions (TSP). When the current coding unit size is equal to the smallest possible coding unit size, the new partitions are not applied. The smallest possible coding unit size is equal to 2̂K in the table. The four T-shaped partitions PART_2N×N_T, PART_2N×N_B, PART_N×2N_L and PART_N×2N_R can be replaced by the four L-shaped partitions PART_2N×N_TL, PART_2N×N_TR, PART_N×2N_BL and PART_N×2N_BR for the case of four “L-shaped” partitions. Also, tsp_enabled_flag can be replaced by lsp_enabled_flag to signal the use of L-Shaped Partitions (LSP) for the case of four “L-shaped” partitions.

TABLE 3

| | | | Bin String | | |
|---|---|---|---|---|---|
| | | | log2CbSize = = | | |
| | | | MinCbLog2SizeY | | |
| | | | && | | log2CbSize |
| CuPredMode | | | log2CbSize > K | | = = |
| [ xCb ][ yCb ] | part_mode | Part Mode | !tsp_enabled_flag | tsp_enabled_flag | K |
| MODE_INTRA | 0 | PART_2Nx2N | 1 | 1 | 1 |
| | 1 | PART_NxN | 0 | 0 | 0 |
| MODE_INTER | 0 | PART_2Nx2N | 1 | 1 | 1 |
| | 1 | PART_2NxN | 01 | 011 | 01 |
| | 2 | PART_Nx2N | 001 | 0011 | 00 |
| | 3 | PART_NxN | 000 | 000 | — |
| | 4 | PART_2NxN_T | — | 0100 | — |
| | 5 | PART_2NxN_B | — | 0101 | — |
| | 6 | PART_Nx2N_L | — | 00100 | — |
| | 7 | PART_Nx2N_R | — | 00101 | — |

In Table 3, tsp_enabled_flag is used to signal the use of T-Shaped Partitions (TSP). When the current coding unit size is equal to the smallest possible coding unit size, the new partitions can be applied as long as smallest possible coding unit size is larger than 2̂K by 2̂K. The smallest possible coding unit size is equal to 2̂K by 2̂K in the table. The four T-shaped partitions PART_2N×N_T, PART_2N×N_B, PART_N×2N_L and PART_N×2N_R can be replaced by the four L-shaped partitions PART_2N×N_TL, PART_2N×N_TR, PART_N×2N_BL and PART_N×2N_BR. Also, tsp_enabled_flag can be replaced by lsp_enabled_flag to signal the use of L-Shaped Partitions (LSP).

If the constraint of “no N×N partition when the current coding unit size equal to 2̂K by 2̂K (i.e., smallest possible coding unit size)” does not apply, the condition of “log 2CbSize>K” in Table 3 can be removed. In other words, for all coding unit sizes, the PART_2N×N_T, PART_2N×N_B, PART_N×2N_L and PART_N×2N_R partitions can co-exist with PART_N×N.

In some other implementations, the new partitions can co-exist with all the supported partitions, such as AMP modes in HEVC.

In the above methods and embodiments, the binarization of 2N×N and N×2N can be swapped. For example, “0011” can be assigned to 2N×N and “011” can be assigned to N×2N. The corresponding extensions of new partitions based on these two modes can be adjusted accordingly.

In some embodiments, the T-shaped partitions can co-exist with L-shaped partitions.

Transform Unit Partitioning

Various new prediction unit partition structures have been disclosed above. Transform process related to these new prediction unit partition structures is also disclosed herein. In one embodiment, a coding unit-level flag is disclosed to indicate if the transform size is equal to the coding unit size. If the sizes are equal, the transform unit will not be further split to smaller units. If the sizes are not equal, the transform block will be split into smaller units. For the T-shaped partitions, the transform units are quadtree split into four smaller transform units according to one embodiment. Accordingly, each prediction unit will contain one or more square transform units without any overlap as shown in FIG. 5A and FIG. 5B. As shown in FIG. 5A, a coding unit is partitioned into prediction units 510 by PART_2N×N_T partition type. If the coding unit level flag indicates “no split”, the transform unit 512 will have the same size as the coding unit. If the coding unit-level flag indicates “split”, the transform units 514 correspond to four sub-blocks partitioned by quadtree splitting. As shown in FIG. 5B, a coding unit is partitioned into prediction units 520 by PART_2N×N_TL partition type. If the coding unit-level flag indicates “no split”, the transform unit 522 will have the same size as the coding unit. If the coding unit-level flag indicates “split”, the transform units 524 correspond to four sub-blocks partitioned by quadtree splitting.

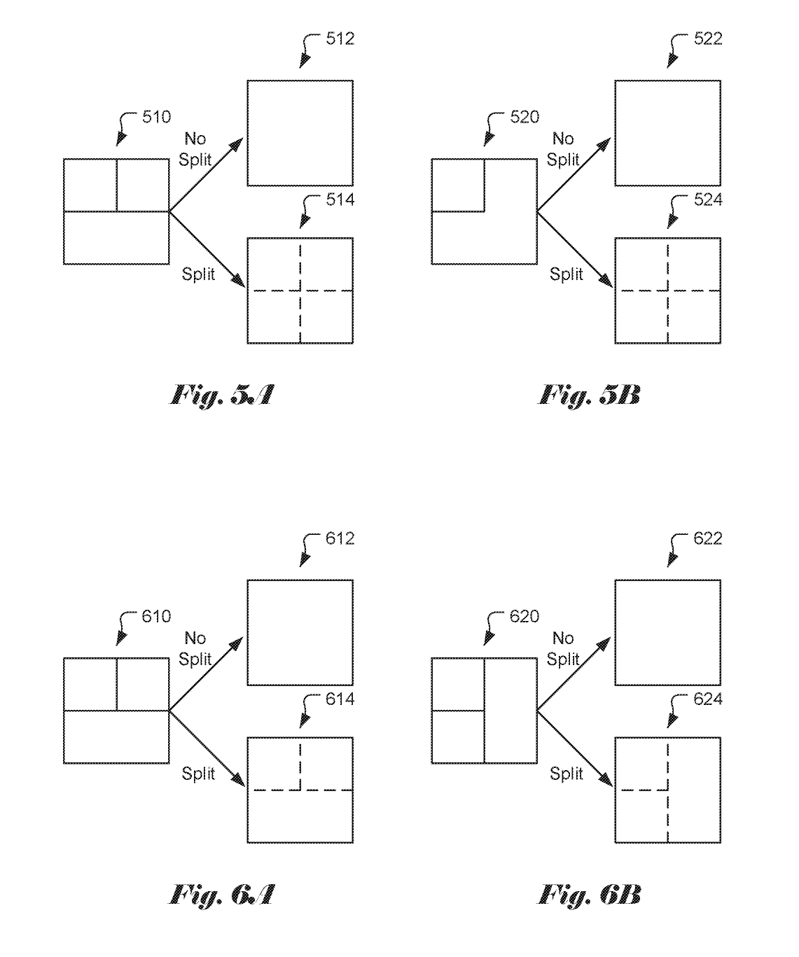

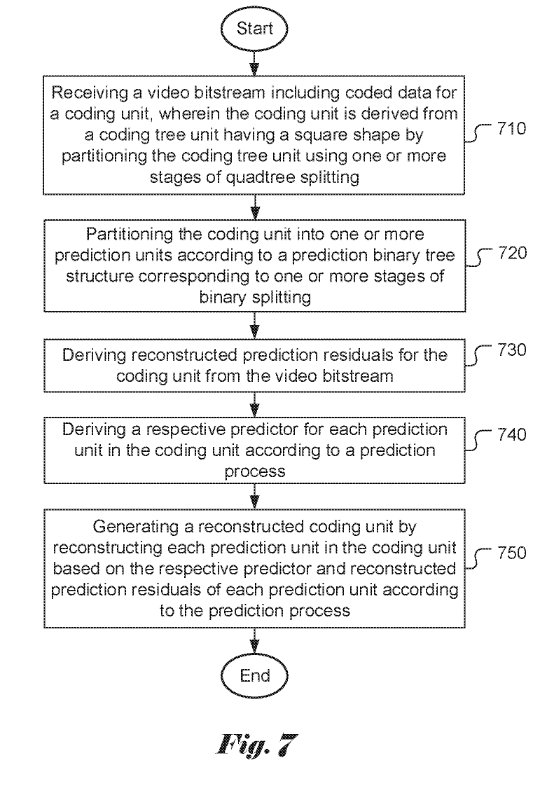

According to another method, each of the transform units will be split into the same size as the corresponding prediction unit in the coding unit for the T-shaped partitions. In this case, the transform unit can be non-square. FIG. 6A and FIG. 6B illustrate examples of transform unit partition according to this embodiment. In FIG. 6A, a coding unit is partitioned into prediction units 610 by PART_2N×N_T partition type. If the coding unit-level flag indicates “no split”, the transform unit 612 will be the same as coding size. If the coding unit-level flag indicates “split”, the transform units 614 correspond to three transform units consisting of one rectangular TU and two smaller square TUs. In FIG. 6B, a coding unit is partitioned into prediction units 620 by PART_N×2N_L partition type. If the coding unit level flag indicates “no split”, the transform unit 622 will have the same size as the coding unit. If the coding unit-level flag indicates “split”, the transform units 624 correspond to three transform units consisting of one rectangular TU and two smaller square TUs.

For the L-shaped partitions, the transform units are quadtree split into four smaller transform units if the transform unit size is not equal to the coding unit size according to an embodiment. In this case, each prediction unit will contain one or more square transform units without any overlap as shown in FIG. 5B.

FIG. 7 illustrates a flowchart of an exemplary decoding system using a binary tree structure to partition a coding unit into one or more prediction units according to an embodiment of the present invention. The steps shown in the flowchart, as well as other following flowcharts in this disclosure, may be implemented as program codes executable on one or more processors (e.g., one or more CPUs) at the encoder side and/or the decoder side. The steps shown in the flowchart may also be implemented based hardware such as one or more electronic devices or processors arranged to perform the steps in the flowchart. According to this method, a video bitstream including coded data for a coding unit is received in step 710, where the coding unit (CU) is derived from a coding tree unit having a square shape by partitioning the coding tree unit using one or more stages of quadtree splitting. The coding unit is partitioned into one or more prediction units (PUs) according to a prediction binary tree structure corresponding to one or more stages of binary splitting in step 720. In other words, the CUs are generated using quadtree splitting and the PUs are generated by partitioning a CU using binary tree splitting. The reconstructed prediction residuals for the coding unit are derived from the video bitstream in step 730. As mentioned before, the encoder encodes the prediction residuals into the video bitstream using processes such as transform, quantization and entropy coding. The reconstructed prediction residuals are derived at the decoder side using the inverse processes such as entropy decoding, de-quantization and inverse transform. A respective predictor for each prediction unit in the coding unit is derived according to a prediction process in step in step 740. For example, if the prediction process corresponds to Intra prediction, the predictor is generated from neighbouring reconstructed pixels according to a selected Intra prediction mode (e.g. an angular mode or planar mode). If the prediction process corresponds to Inter prediction, the predictor is generated from one or more reference pictures depending on uni-prediction or bi-prediction and based on the motion vector(s). A reconstructed coding unit can be generated by reconstructing each prediction unit in the coding unit based on the respective predictor and reconstructed prediction residuals of each prediction unit according to the prediction process in step 750.

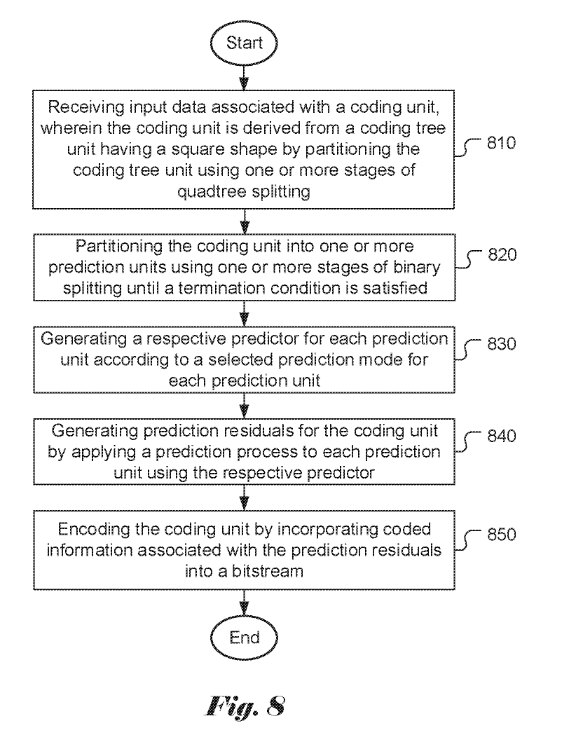

FIG. 8 illustrates a flowchart of an exemplary encoding system using a binary tree structure to partition a coding unit into one or more prediction units according to an embodiment of the present invention. According to this method, input data associated with a coding unit are receiving in step 810, where the coding unit is derived from a coding tree unit having a square shape by partitioning the coding tree unit using one or more stages of quadtree splitting. The coding unit is partitioned into one or more prediction units using one or more stages of binary splitting until a termination condition is satisfied in step 820. Various termination conditions have been disclosed above, such as the PU reaches a minimum size or minimum width/height, or the partition tree reaches a maximum depth. A respective predictor for each prediction unit is generated according to a selected prediction mode for each prediction unit in step 830. Prediction residuals for the coding unit are generated by applying a prediction process to each prediction unit using the respective predictor in step 840. The coding unit is encoded by incorporating coded information associated with the prediction residuals into a bitstream in step 850.

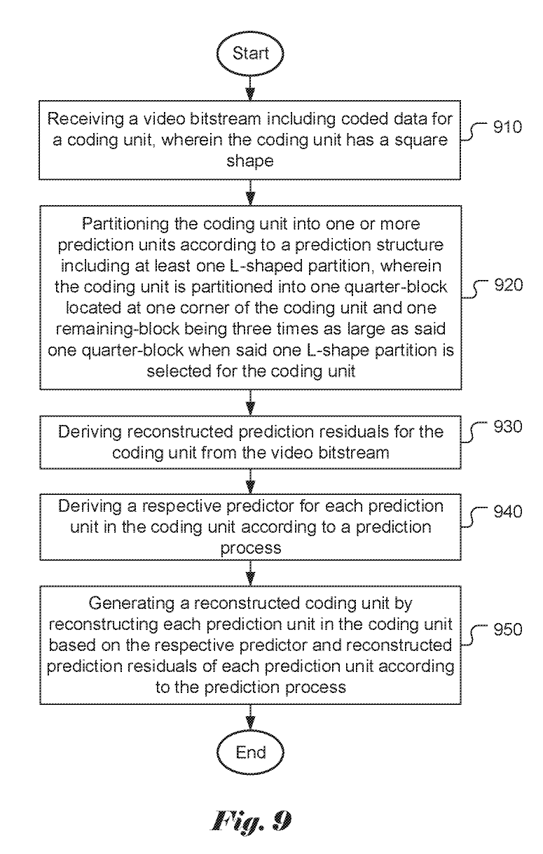

FIG. 9 illustrates a flowchart of an exemplary decoding system using a prediction unit partition structure including at least one “L-shaped” partition according to an embodiment of the present invention. According to this method, a video bitstream including coded data for a coding unit is received in step 910, where the coding unit (CU) has a square shape. The coding unit is partitioned into one or more prediction units according to a prediction structure including at least one L-shaped partition in step 920, wherein the coding unit is partitioned into one quarter-block located at one corner of the coding unit and one remaining-block being three times as large as said one quarter-block when said one L-shape partition is selected for the coding unit. The reconstructed prediction residuals for the coding unit are derived from the video bitstream in step 930. A respective predictor for each prediction unit in the coding unit is derived according to a prediction process in step in step 940. A reconstructed coding unit can be generated by reconstructing each prediction unit in the coding unit based on the respective predictor and reconstructed prediction residuals of each prediction unit according to the prediction process in step 950.

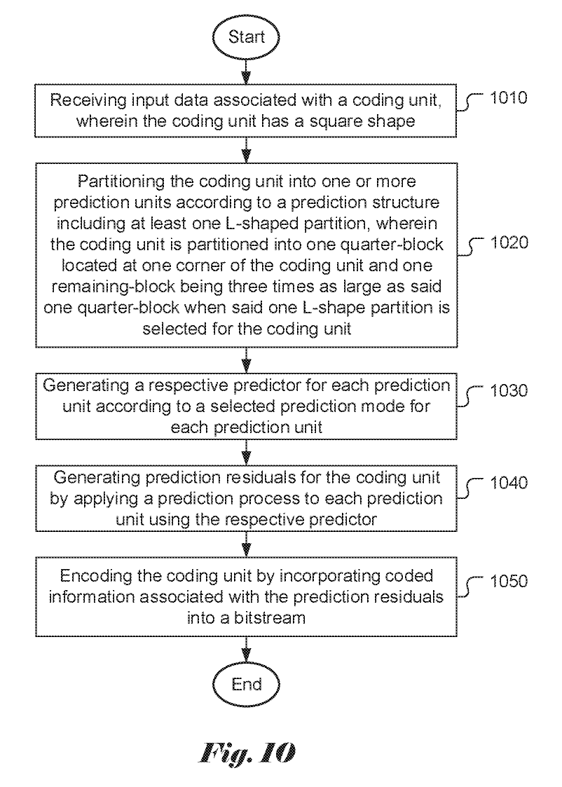

FIG. 10 illustrates a flowchart of an exemplary encoding system using a prediction unit partition structure including at least one “L-shaped” partition according to an embodiment of the present invention. According to this method, input data associated with a coding unit are receiving in step 1010, where the coding unit has a square shape. The coding unit is partitioned into one or more prediction units according to a prediction structure including at least one L-shaped partition in step 1020, wherein the coding unit is partitioned into one quarter-block located at one corner of the coding unit and one remaining-block being three times as large as said one quarter-block when said one L-shape partition is selected for the coding unit. A respective predictor for each prediction unit is generated according to a selected prediction mode for each prediction unit in step 1030. Prediction residuals for the coding unit are generated by applying a prediction process to each prediction unit using the respective predictor in step 1040. The coding unit is encoded by incorporating coded information associated with the prediction residuals into a bitstream in step 1050.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video decoding, the method comprising:
receiving a video bitstream including coded data for a coding unit, wherein the coding unit is derived from a coding tree unit having a square shape by partitioning the coding tree unit using one or more stages of quadtree splitting;
partitioning the coding unit into one or more prediction units according to a prediction binary tree structure corresponding to one or more stages of binary splitting;
deriving reconstructed prediction residuals for the coding unit from the video bitstream;
deriving a respective predictor for each prediction unit in the coding unit according to a prediction process; and
generating a reconstructed coding unit by reconstructing each prediction unit in the coding unit based on the respective predictor and reconstructed prediction residuals of each prediction unit according to the prediction process.

2. The method of claim 1 further comprising deriving the prediction binary tree structure from the video bitstream.

3. The method of claim 2, wherein a first flag in the video bitstream is used for the prediction binary tree structure to indicate whether one given block is split into two blocks of equal size.

4. The method of claim 3, wherein if the first flag indicates said one given block being split into two blocks of equal size, a second flag in the video bitstream is used for the prediction binary tree structure to indicate horizontal splitting or vertical splitting.

5. The method of claim 2, wherein an allowed minimum prediction unit size, an allowed minimum prediction unit width or an allowed minimum prediction unit height, or maximum depth associated with the prediction binary tree structure is determined from the video bitstream in sequence parameter set (SPS) or picture parameter set (PPS).

6. The method of claim 1, further comprising determining, a third flag from the video bitstream, wherein the third flag indicates whether the coding unit and a transform unit associated with the coding unit have a same first block size.

7. The method of claim 6, wherein if the third flag indicates that the coding unit does not have the same first block size as any transform unit associated with the coding unit, each prediction unit has one corresponding transform unit with a same second block size of said each prediction unit.

8. The method of claim 6, wherein if the third flag indicates that the coding unit does not have the same first block size as any transform unit associated with the coding unit, the coding unit is divided into one or more transform units using one or more stages of quadtree splitting and each transform unit includes only pixels from one prediction unit.

9. The method of claim 1, wherein the coding unit comprises a luma component and a chroma component, and wherein a same prediction binary tree structure is used for the luma component and the chroma component of the coding unit.

10. The method of claim 1, wherein the prediction binary tree structure includes at least one T-shaped partition, wherein the T-shaped partition divides the coding unit into a first half-block and a second half-block in a first direction corresponding to a vertical direction or a horizontal direction and one of the first half-block and the second half-block is further divided into two quarter-blocks in a second direction perpendicular to the first direction.

11. The method of claim 10, wherein the prediction binary tree structure comprises four T-shaped partitions, and wherein one half-block being further divided to generate one of the four T-shaped partitions corresponds to an upper half-block, a lower half-block, a left half-block or a right half-block.

12. The method of claim 11, wherein the prediction binary tree structure further comprises 2N×2N, 2N×N and N×2N partitions.

13. The method of claim 12, wherein a T-shaped partition enable flag is used to indicate use of the four T-shaped partitions in the prediction binary tree structure, wherein three first binary strings are used for signalling the 2N×2N, 2N×N and N×2N partitions when the T-shaped partition enable flag indicates the T-shaped partition being disabled.

14. The method of claim 13, wherein if the T-shaped partition enable flag indicates the T-shaped partition being enabled, one additional bit is appended to each of two first binary strings representing 2N×N and N×2N partitions to indicate whether corresponding 2N×N or N×2N partition is further partitioned into one T-shaped partition, and four second binary strings are used for signalling the four T-shaped partitions and the four second binary strings are generated by appending two bits to each of two first binary strings.

15. The method of claim 11, wherein the prediction binary tree structure further comprises AMP (asymmetric motion partition) including 2N×N and N×2N partitions.

16. The method of claim 15, wherein a T-shaped partition enable flag is used to indicate use of the four T-shaped partitions in the prediction binary tree structure, wherein first binary strings are used for signalling the AMP when the T-shaped partition enable flag indicates the T-shaped partition being disabled.

17. The method of claim 16, wherein if the T-shaped partition enable flag indicates the T-shaped partition being enabled, one additional bit is appended to each of two first binary strings representing 2N×N and N×2N partitions to indicate whether corresponding 2N×N or N×2N partition is further partitioned into one T-shaped partition, and four second binary strings are used for signalling the four T-shaped partitions and the four second binary strings are generated by appending two bits to each of two first binary strings.

18. An apparatus of video decoding for a video decoder, the apparatus comprising one or more electronic circuits or processors arrange to:
receive a video bitstream including coded data for a coding unit, wherein the coding unit is derived from a coding tree unit having a square shape by partitioning the coding tree unit using one or more stages of quadtree splitting;
partition the coding unit into one or more prediction units according to a prediction binary tree structure corresponding to one or more stages of binary splitting;
derive reconstructed prediction residuals for the coding unit from the video bitstream;
derive a respective predictor for each prediction unit in the coding unit according to a prediction process; and
generate a reconstructed coding unit by reconstructing each prediction unit in the coding unit based on the respective predictor and reconstructed prediction residuals of each prediction unit according to the prediction process.

19. A method of video encoding, the method comprising:
receiving input data associated with a coding unit, wherein the coding unit is derived from a coding tree unit having a square shape by partitioning the coding tree unit using one or more stages of quadtree splitting;
partitioning the coding unit into one or more prediction units using one or more stages of binary splitting until a termination condition is satisfied;
generating a respective predictor for each prediction unit according to a selected prediction mode for each prediction unit; and
generating prediction residuals for the coding unit by applying a prediction process to each prediction unit using the respective predictor; and
encoding the coding unit by incorporating coded information associated with the prediction residuals into a bitstream.

20. A method of video decoding, the method comprising:
receiving a video bitstream including coded data for a coding unit, wherein the coding unit has a square shape;
partitioning the coding unit into one or more prediction units according to a prediction structure including at least one L-shaped partition, wherein the coding unit is partitioned into one quarter-block located at one corner of the coding unit and one remaining-block being three times as large as said one quarter-block when said one L-shape partition is selected for the coding unit;
deriving reconstructed prediction residuals for the coding unit from the video bitstream;
deriving a respective predictor for each prediction unit in the coding unit according to a prediction process; and
generating a reconstructed coding unit by reconstructing each prediction unit in the coding unit based on the respective predictor and reconstructed prediction residuals of each prediction unit according to the prediction process.

21. The method of claim 20, wherein the prediction structure comprises four L-shaped partitions and wherein said one quarter-block associated with the four L-shaped partitions corresponds to an upper-left quarter-block, a lower-left quarter-block, an upper-right quarter-block or a lower-right quarter-block.

22. The method of claim 21, wherein the prediction structure further comprises 2N×2N, 2N×N and N×2N partitions.

23. The method of claim 22, wherein four binary strings consisting of a prefix symbol followed by two bits are used to represent the four L-shaped partitions.

24. The method of claim 22, wherein an L-shaped partition enable flag is used to indicate use of the four L-shaped partitions in the prediction structure, wherein three first binary strings are used for signalling the 2N×2N, 2N×N and N×2N partitions when the L-shaped partition enable flag indicates the L-shaped partition being disabled.

25. The method of claim 24, wherein if the L-shaped partition enable flag indicates the L-shaped partition being enabled, one additional bit is appended to each of two first binary strings representing 2N×N and N×2N partitions to indicate whether corresponding 2N×N or N×2N partition is further modified into one L-shaped partition, and four second binary strings are used for signalling the four L-shaped partitions and the four second binary strings are generated by appending two bits to each of two first binary strings.

26. The method of claim 21, wherein the prediction structure further comprises AMP (asymmetric motion partition).

27. An apparatus of video decoding for a video decoder, the apparatus comprising one or more electronic circuits or processors arrange to:
receive a video bitstream including coded data for a coding unit, wherein the coding unit has a square shape;
partitioning the coding unit into one or more prediction units according to a prediction structure including at least one L-shaped partition, wherein the coding unit is partitioned into one quarter-block located at one corner of the coding unit and one remaining-block being three times as large as said one quarter-block when said one L-shape partition is selected for the coding unit;
derive reconstructed prediction residuals for the coding unit from the video bitstream;
derive a respective predictor for each prediction unit in the coding unit according to a prediction process; and
generate a reconstructed coding unit by reconstructing each prediction unit in the coding unit based on the respective predictor and reconstructed prediction residuals of each prediction unit according to the prediction process.

28. A method of video encoding, the method comprising:
receiving input data associated with a coding unit, wherein the coding unit has a square shape;
partitioning the coding unit into one or more prediction units according to a prediction structure including at least one L-shaped partition, wherein the coding unit is partitioned into one quarter-block located at one corner of the coding unit and one remaining-block being three times as large as said one quarter-block when said one L-shape partition is selected for the coding unit;
generating a respective predictor for each prediction unit according to a selected prediction mode for each prediction unit; and
generating prediction residuals for the coding unit by applying a prediction process to each prediction unit using the respective predictor; and
encoding the coding unit by incorporating information associated with the prediction residuals into a bitstream.
